(19) United States
(12) Patent Application Publication
(10) Pub. No.: US 2024/0210338 A1
(43) Pub. Date: Jun. 27, 2024

(54) DEW POINT HYGROMETER

(71) Applicant: The Research Foundation for the State University of New York, Albany, NY (US)

(72) Inventor: Vladimir Samuilov, Sound Beach, NY (US)

(21) Appl. No.: 17/913,898

(22) PCT Filed: Mar. 24, 2021
(86) PCT No.: PCT/US2021/023858

§ 371 Date: Sep. 23, 2022

Related U.S. Application Data
(60) Provisional application No. 62/993,858, filed on Mar. 24, 2020.

(51) Int. Cl. G01N 25/66

(52) U.S. Cl. CPC G01N 25/66

(57) ABSTRACT

A dew point hygrometer is provided that contains a condensation sensor that is composed of a moisture sensitive hydrophilic material that has a measurable physical parameter which is moisture dependent. Notably, the measurable physical parameter of the moisture sensitive hydrophilic material varies over a decreasing temperature range. A maximum rate of increase in the measurable physical parameter over the decreasing temperature range is indicative of a dew point temperature and a maximum rate of water molecules adsorption and their dissociation on a surface of the moisture sensitive hydrophilic material. Also, a maximum in a measurable physical parameter over the decreasing temperature range is indicative of a transition to an icing condition, if the dew point temperature is greater than 0° C., or a frost point, if the dew point temperature is less than 0° C.

### RELATED APPLICATION

This application claims the benefit of, and priority to, U.S. Provisional Application No. 62/993,858 filed on Mar. 24, 2020, the entirety of which is incorporated by reference.

### FIELD OF THE DISCLOSURE

The present disclosure generally relates to a dew point hygrometer, a system containing the dew point hygrometer, and a method of determining dew point utilizing the dew point hygrometer of the present disclosure.

### BACKGROUND

The accurate measurement of humidity is crucial to a number of diverse fields, including for example, meteorology, materials processing and manufacturing and environmental control (HVAC). Presently, instruments which accurately measure water vapor concentration (i.e., dew point) typically use optical techniques consisting of a water adsorbing surface and optical detection. Dew point (abbreviated as T_{D}) is a measure of the absolute amount of moisture in air regardless of temperature. It is called dew point because the value actually predicts at what temperature moisture will condense on a surface. Dew point is an excellent means of controlling humidity because, unlike relative humidity that varies with temperature, dew point provides an indication of moisture content in air and will remain constant regardless of temperature. Only very expensive, temperature-variation based laboratory grade sensors can measure dew point (i.e., chilled mirror hygrometers).

A dew point hygrometer detects the dew point temperature of air by cooling a surface in contact with the air to the dew point temperature. The early dew point hygrometers were cooled simply by applying the vaporization of ether or some other suitable liquid. These days—by contact with the surface of a (thermoelectric) Peltier element.

The observation may be made by a lamp illuminating the surface and a photocell to detect the scattered light due to the water droplets (ice) on the surface. The accurate measurement of the surface temperature, which is the dew point temperature, is critical.

The range of dew point hygrometers depends on the temperature range of the cooled surface. In principle, a temperature range of air from −100° C. to +30° C. can be covered. The dew point hygrometer is said to be the most accurate instrument for measuring air humidity. On the whole, the dew point hygrometer is a reliable fundamental instrument suitable for many applications.

Chilled mirror hygrometers are used in standards and metrology labs as well as in industrial applications where precise and repeatable humidity measurement and control is required. Since chilled mirrors fundamentally measure the dew point temperature or frost point temperature directly by controlling a reflective surface to equilibrium between dew/frost formation and evaporation and precisely measuring the temperature of the mirror at this point, the methodology has been validated by standards labs worldwide. Standard chilled mirrors are capable of measuring dew/frost points from −90° C. to +30° C. with an accuracy of +/−0.15° C.

Despite the above, there is a need for providing a dew point hygrometer that is capable of direct and precise determination of dew point temperature which is more cost efficient and simple to use than conventional chilled mirror hygrometers.

### SUMMARY

A dew point hygrometer is provided that contains a condensation sensor that is composed of a moisture sensitive hydrophilic material that has a measurable physical parameter which is moisture dependent. Notably, the measurable physical parameter of the moisture sensitive hydrophilic material varies over a decreasing temperature range. A maximum rate of increase in the measurable physical parameter over the decreasing temperature range is indicative of a dew point temperature and a maximum rate of water molecules adsorption and their dissociation on a surface of the moisture sensitive hydrophilic material. Also, a maximum in a measurable physical parameter over the decreasing temperature range is indicative of a transition to an icing condition, if the dew point temperature is greater than 0° C., or a frost point, if the dew point temperature is less than 0° C.

In one aspect of the present disclosure, a hygrometer for detecting dew point is provided. In one embodiment, the hygrometer includes a condensation sensor having an outer surface composed of a moisture sensitive hydrophilic material. The moisture sensitive hydrophilic material that is employed in the present disclosure has a DC proton conductivity that varies over a decreasing temperature range, and a maximum rate of increase in the DC proton conductivity over the decreasing temperature range is indicative of a dew point temperature (T_{D}).

In addition to being indicative of the dew point temperature, the maximum rate of increase in the DC proton conductivity is further indicative of a maximum rate of water molecules adsorption and their dissociation on a surface of the moisture sensitive hydrophilic material.

In embodiments of the present disclosure, a maximum in the DC proton conductivity of the moisture sensitive hydrophilic material over the decreasing temperature range is indicative of a transition to an icing condition, if the dew point temperature is greater than 0° C. In other embodiments, a maximum in the DC proton conductivity of the moisture sensitive hydrophilic material over the decreasing temperature range is indicative of a frost point (T_{F}), if the dew point temperature is less than 0° C.

In some embodiments of the present disclosure, the moisture sensitive hydrophilic material that has a DC proton conductivity that is dependent on temperature is composed of an electronically insulating material having chemical groups containing oxygen. In one example, the moisture sensitive hydrophilic material that has a DC proton conductivity that is dependent on temperature is composed of graphene oxide.

In one preferred embodiment, the hygrometer includes a condensation sensor having an outer surface composed of a graphene oxide, wherein the graphene oxide has a proton conductivity that varies over a decreasing temperature range, wherein a maximum rate of increase in the proton conductivity over the decreasing temperature range is indicative of a dew point temperature and a maximum rate of water molecules adsorption and their dissociation on a surface of the graphene oxide, and wherein a maximum in the proton conductivity of the graphene oxide over the decreasing temperature range is indicative of a transition to an icing condition, if the dew point temperature is greater than 0° C., or a frost point, if the dew point temperature is less than 0° C.

In another aspect of the present disclosure, a system for determining dew point is provided. In one embodiment, the system includes a hygrometer comprising a condensation sensor having an outer surface composed of a moisture sensitive hydrophilic material, wherein the moisture sensitive hydrophilic material has a DC proton conductivity that varies over a decreasing temperature range, and wherein a maximum rate of increase in the DC proton conductivity over the decreasing temperature range is indicative of a dew point temperature. The system of the present disclosure can also include a signal conditioner, and a processor which is configured to monitor the DC proton conductivity of the moisture sensitive hydrophilic material over the decreasing temperature range and to identify at least the maximum rate of increase in the DC proton conductivity over the decreasing temperature range. In one preferred embodiment, the moisture sensitive hydrophilic material is composed of graphene oxide.

In a further aspect of the present disclosure, a method of determining dew point is provided. In one embodiment, the method includes contacting a condensation sensor having an outer surface composed of a moisture sensitive hydrophilic material. A change in a DC proton conductivity of the moisture sensitive hydrophilic material is then measured across the condensation sensor and over a decreasing temperature range. In accordance with the present disclosure, a maximum rate of increase in the DC proton conductivity over the decreasing temperature range is indicative of a dew point temperature. Also, a maximum in the DC proton conductivity of the moisture sensitive hydrophilic material over the decreasing temperature range is indicative of a transition to an icing condition, if the dew point temperature is greater than 0° C., or a frost point, if the dew point temperature is less than 0° C.

### BRIEF DESCRIPTION OF DRAWINGS

FIG. 1 illustrates an exemplary system which includes a condensation sensor in accordance with the present disclosure.

FIG. 2 is a plot of conductance vs. temperature generated utilizing a system as shown in FIG. 1; four curves, Curve A, Curve B, Curve C and Curve D are shown. Also, the positions of the first derivative (dSigma/dT=0) and the second derivative (d²Sigma/dT²=0) for each curve are shown; Sigma is represented as Σ in the drawings.

FIG. 3 is an experimental plot of conductance vs. temperature at dew points corresponding to Curves B and C as shown in FIG. 2.

### DETAILED DISCUSSION

The present disclosure will now be described in greater detail by referring to the following discussion and drawings that accompany the present disclosure. It is noted that the drawings of the present disclosure are provided for illustrative purposes only and, as such, the drawings are not drawn to scale. It is also noted that like and corresponding elements are referred to by like reference numerals.

In the following description, numerous specific details are set forth, such as particular structures, components, materials, dimensions, processing steps and techniques, in order to provide an understanding of the various embodiments of the present disclosure. However, it will be appreciated by one of ordinary skill in the art that the various embodiments of the present disclosure may be practiced without these specific details. In other instances, well-known structures or processing steps have not been described in detail in order to avoid obscuring the present disclosure.

The present disclosure provides a hygrometer that is cost efficient and simple to use. The inventive hygrometer includes a condensation sensor having a moisture sensitive hydrophilic material on at least a surface thereof. The moisture sensitive hydrophilic material that is employed has a measurable physical parameter that varies over a decreasing temperature range, and fundamentally measures the dew point temperature by directly detecting the maximum rate of water molecules adsorption on the sensor's surface (the coverage of the sensor's surface with the water molecules changes with the highest rate). The hygrometer of the present disclosure can also be used to determine a transition to an icing condition or frost point by measuring a maximum in the measurable physical parameter over the temperature. The hygrometer of the present disclosure can be used to determine at least the dew point temperature of water in air. In some embodiments, the hygrometer of the present disclosure can be used to determine at least the dew point temperature of water in other gas streams including, but not limited to, hydrocarbon gas steams (i.e., methane, butane, etc.).

In the present disclosure, the measurable physical parameter of the moisture sensitive hydrophilic material is DC proton conductivity. In the present disclosure, when the moisture sensitive hydrophilic material is initially exposed to moisture, water adsorbed molecules interact with hydrophilic functional groups of the moisture sensitive hydrophilic material thus generating protons (H+) which transport across a surface of the moisture sensitive hydrophilic material. These generated and transported protons can be detected, and can be used to provide accurate dew point temperatures. The present disclosure is based on the experimental DC measurements vs. temperature at fixed, different and well-determined humidity levels.

In addition to including the condensation sensor of the present disclosure, the hygrometer can be used in conjunction with well known components that are typically present in a conventional hygrometer. For example, the hygrometer of the present disclosure can be equipped with a thermal device configured to generate heating or cooling to change a temperature of the condensation sensor, a temperature sensor for measuring a temperature of the condensation sensor, a controller configured to control the thermal device, a direct current voltage source configured to supply a current at a fixed voltage to the condensation sensor, and a current measurement device (i.e., detector) configured to measure the conductance of the condensation sensor after water adsorption.

In some embodiments, the hygrometer can be used in a system that includes a current amplifier, a signal conditioner (i.e., an analog-digital converter) and a processor configured to monitor the measurable physical parameter of the moisture sensitive hydrophilic material over the decreasing temperature range and to identify at least the maximum rate of increase in the measurable physical parameter (i.e., DC proton conductivity) over the decreasing temperature range.

In some embodiments of the present disclosure, the various components described in U.S. Pat. Nos. 9,086,363 and 10,101,219, the entire contents of each of which are incorporated herein by reference, can be used in conjunction with the condensation sensor of the present disclosure.

In accordance with the present disclosure, the processor can be a CPU. The CPU is configured to execute one or more programs stored in a computer readable storage device. The computer readable storage device can be RAM, persistent storage or removable storage. For example, the CPU can execute instructions in a program that may be loaded into RAM. Computer readable storage device may be in a tangible or hardware form, such as, an optical or magnetic disc that is inserted or placed into a drive or other portion or device for transfer onto an internal storage device, such as a hard drive. Additionally, the computer readable storage device also may take the form of a hard drive, a thumb drive, or a flash memory that is connected to CPU. The processor may include one or more processing units.

RAM, ROM and Persistent Storage are only examples of Data Storage Devices. A storage device is any piece of hardware that is capable of storing information, such as, for example without limitation, data, programs, instructions, program code, and/or other suitable information either on a temporary basis and/or a permanent basis. Persistent Storage can take various forms. For example, persistent Storage can contain one or more components or devices. For example, Persistent Storage may be a hard drive (e.g., HDD), a flash memory, a rewritable optical disk, a rewritable magnetic tape, or some combination of the above. The medium or media used by Persistent Storage also may be removable. For example, a removable hard drive may be used.

Alternative, the processor can be a FPGA or PAL.

Notably, the condensation sensor of the present disclosure has at least an outer surface that is composed of a moisture sensitive hydrophilic material which has a measurable physical parameter, i.e., DC proton conductivity (or proton conductance), that varies over a temperature range which decreases from a high temperature to a low temperature. In one example, the decreasing temperature range is a range from 300° Kelvin (K) to 200° K. The decreasing temperature can be achieved utilizing temperature controlling means that are well known to those skilled in the art including, for example, the temperature controlling means disclosed in U.S. Pat. No. 10,101,219, which disclosure was previously incorporated herein by reference.

By “moisture sensitive”, it is meant that the material is a high affinity for the adsorption of water molecules. By “hydrophilic”, it is meant that the material has a high affinity of attracting or associating with water molecules. In the present disclosure, the moisture sensitive hydrophilic material that is employed has chemical functional groups containing oxygen, e.g., carboxyl groups or carbonyl groups, and is electronically insulating. The moisture sensitive hydrophilic materials that can be used in the present disclosure thus includes an electronically insulating material that has a DC proton conductivity that can be measured and which varies over a decreasing temperature range. In one example, graphene oxide can be used as the moisture sensitive hydrophilic material. In such an embodiment, the basal planes and edges of graphene oxide platelets that define the graphene oxide are composed of distributed groups containing oxygen which increases the hydrophilcity of the graphene oxide and consequently enhances the sensitivity of the condensation sensor to water. In some embodiments and when graphene oxide is employed as the moisture sensitive material, the condensation sensor has a moisture sensitivity that is three orders of magnitude higher than conventional condensation sensors.

In addition to graphene oxide, other examples of moisture sensitive hydrophilic materials, which are electronically insulating and have a DC proton conductivity that varies over a decreasing temperature range, include, but are not limited to, a sulfonated tetrafluoroethylene based fluoropolymer-copolymer (commercially available under the brand name Nafion®). Other ionomers besides sulfonated tetrafluoroethylene based fluoropolymer-copolymer can also be employed as long as the other ionomers are electronically insulating and have a DC proton conductivity that varies over a decreasing temperature range.

In some embodiments, the entirety of the condensation sensor is composed of the moisture sensitive hydrophilic material. In other embodiments, only a surface of the condensation sensor is composed of the moisture sensitive hydrophilic material. In such an embodiment, the moisture sensitive hydrophilic material is a film that is disposed on a substrate. Exemplary substrates include, but are not limited to, a ceramic. The film of the moisture sensitive hydrophilic material that is present on the substrate can have a thickness from 100 nm to 10,000 nm. Other thicknesses for the sensitive hydrophilic material film are however contemplated and can be used in the present disclosure.

The moisture sensitive hydrophilic material that can be employed in the present disclosure can be formed utilizing techniques well known to those skilled in the art. For example, graphene oxide can be formed utilizing a filtering method that includes the use of a water suspension of graphene oxide nanoparticles. The moisture sensitive hydrophilic material can be deposited on a surface of a substrate utilizing well known deposition processes such as, for example, spin coating or dip coating.

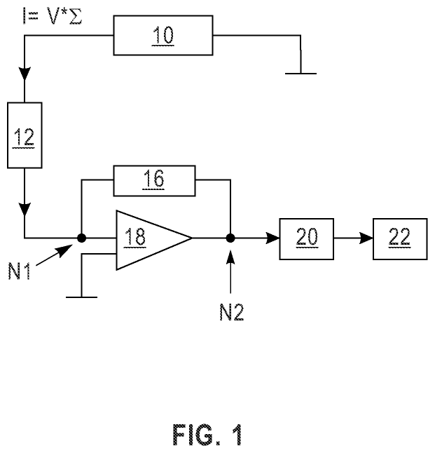

Referring now to FIG. 1 there is illustrated an exemplary system which includes a condensation sensor 12 in accordance with the present disclosure. That is, the condensation sensor 12 is one in which at least an outer surface thereof is composed of a moisture sensitive hydrophilic material as defined herein, wherein the moisture sensitive hydrophilic material has a direct current (DC) proton conductivity that varies over a decreasing temperature range. In one example, the condensation sensor 12 is composed of graphene oxide. As is shown, the system can also include a direct current source 10 that is configured to generate DC voltage. The DC voltage applied to the condensation sensor 12 generates DC current in the condensation sensor 12 which is transmitted along the entire surface of the condensation sensor 12. The generated DC current that is present in the condensation sensor 12 represents the DC proton current at a given temperature. This DC proton current is detected, amplified and converted to the voltage signal by the current amplifier 18 with a feedback resistance 16 that determines the coefficient of the amplification\conversion Uₒᵤₜₚᵤₜ=I×R_{feedback} sent to the signal controller (i.e., analog to digital converter) 20 and thereafter to processor 22. The processor 22 can be used to determine a graph (i.e., plot) of proton conductance vs. temperature, and this plot can be used to at least determine the dew point temperature.

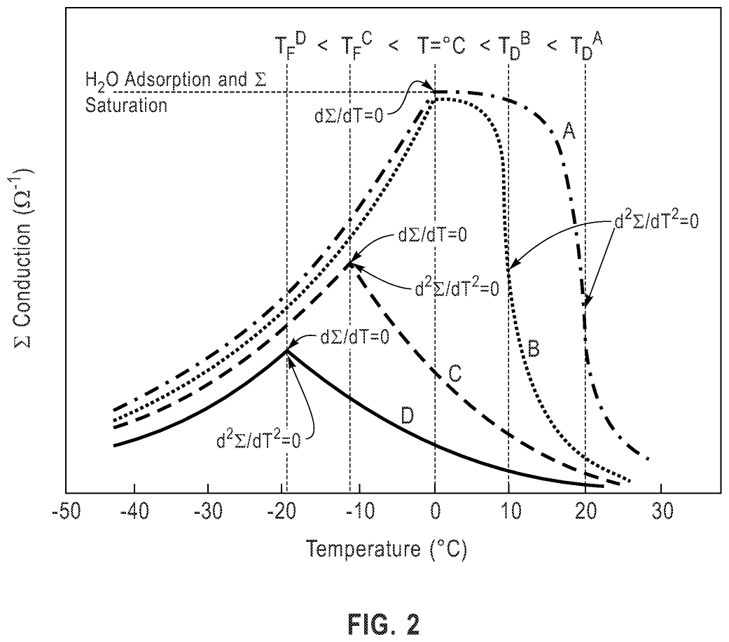

Notably, the hygrometer of the present disclosure can be used to determine a dew point temperature. In accordance with the present disclosure, the method includes contacting a condensation sensor as defined above and having an outer surface composed of one of the above mentioned moisture sensitive hydrophilic material with moisture. In the present disclosure, the moisture is in typically in air, and the air has a humidity level from T_{D} approximately −50° C. to T_{D} approximately 20° C. Next, a change in a physical parameter (i.e., DC proton conductivity) of the moisture sensitive hydrophilic material is measured across the condensation sensor and over a decreasing temperature range. The measurements may be made utilizing the system illustrated in FIG. 1 and at various temperatures starting from a high temperature (e.g., 300° K) to a low temperature (e.g., 200° K) such that a plot of conductance vs. temperature as is shown in FIG. 2 can be generated. In FIG. 2, Curve A is at T_{D} approximately 20° C., Curve B is at T_{D} approximately 10° C., Curve C is T_{F} (frost temperature) of approximately −10° C., and Curve D is T_{F} of approximately −20° C. For each curve shown in FIG. 2, the first derivative (dSigma/dT=0) and the second derivative (d²Sigma/dT²=0) are shown. The first and second derivates can be calculated by a software or program that is contained within, or supplied to, the processor.

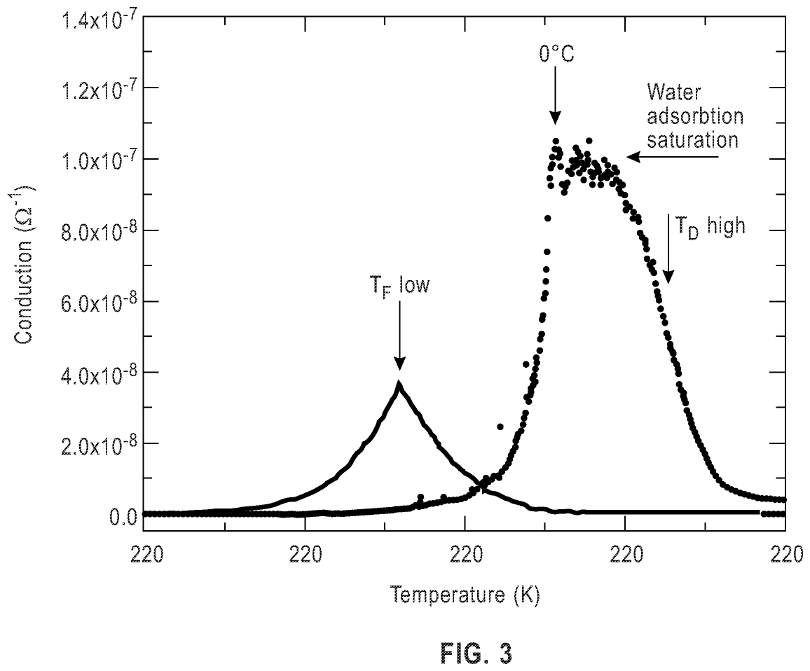

FIG. 3 shows experimental plot of conductance vs. temperature at dew points approximately corresponding to the Curves B and C as shown in FIG. 2. The condensation sensor used in generating the plot shown in FIG. 3 includes graphene oxide as the moisture sensitive hydrophilic material.

It should be noted that the maximum rate of increase in the DC proton conductivity over the decreasing temperature range, which is indicative of the dew point temperature, represents an inflection point of the curves within the conductance vs. temperature plots. Also, it is noted that the maximum in the DC proton conductivity of the moisture sensitive hydrophilic material over the decreasing temperature range, which is indicative of a transition to an icing condition or frost point, is followed by an immediate change of the temperature coefficient.

In the present disclosure, a maximum in the DC proton conductivity of the moisture sensitive hydrophilic material over the decreasing temperature range (as represented by the first derivative (dSigma/dT=0)) is indicative of a transition to an icing condition, if the dew point temperature is greater than 0° C., or a frost point (T_{F}), if the dew point temperature is less than 0° C. Icing or frost point occurs at the abrupt conductance drop of the condensation sensor. In the present disclosure, a maximum rate of increase in the DC proton conductivity over the decreasing temperature range (as represented by the second derivative (d²Sigma/dT²=0) is indicative of a dew point temperature. That is, the dew point temperature is easily detected as an inflection point of the temperature dependence of the conductance. Also, and in the present disclosure the maximum rate of increase in the DC proton conductivity is further indicative of a maximum rate of water molecules adsorption and their dissociation on a surface of the moisture sensitive hydrophilic material.

Various aspects of the present disclosure may be embodied as a program, software, or computer instructions embodied or stored in a computer or machine usable or readable medium, or a group of media which causes the computer or machine to perform the steps of the method when executed on the computer, processor, and/or machine. A program storage device readable by a machine, e.g., a computer readable medium, tangibly embodying a program of instructions executable by the machine to perform various functionalities and methods described in the present disclosure is also provided, e.g., a computer program product.

The computer readable medium could be a computer readable storage device or a computer readable signal medium. A computer readable storage device, may be, for example, a magnetic, optical, electronic, electromagnetic, infrared, or semiconductor system, apparatus, or device, or any suitable combination of the foregoing; however, the computer readable storage device is not limited to these examples except a computer readable storage device excludes computer readable signal medium. Additional examples of the computer readable storage device can include: a portable computer diskette, a hard disk, a magnetic storage device, a portable compact disc read-only memory (CD-ROM), a random access memory (RAM), a read-only memory (ROM), an erasable programmable read-only memory (EPROM or Flash memory), an optical storage device, or any appropriate combination of the foregoing; however, the computer readable storage device is also not limited to these examples. Any tangible medium that can contain, or store, a program for use by or in connection with an instruction execution system, apparatus, or device could be a computer readable storage device.

A computer readable signal medium may include a propagated data signal with computer readable program code embodied therein, such as, but not limited to, in baseband or as part of a carrier wave. A propagated signal may take any of a plurality of forms, including, but not limited to, electro-magnetic, optical, or any suitable combination thereof. A computer readable signal medium may be any computer readable medium (exclusive of computer readable storage device) that can communicate, propagate, or transport a program for use by or in connection with a system, apparatus, or device. Program code embodied on a computer readable signal medium may be transmitted using any appropriate medium, including but not limited to wireless, wired, optical fiber cable, RF, etc., or any suitable combination of the foregoing.

The term “processor” as may be used in the present disclosure may include a variety of combinations of fixed and/or portable computer hardware, software, peripherals, and storage devices. The “processor” may include a plurality of individual components that are networked or otherwise linked to perform collaboratively, or may include one or more stand-alone components. The hardware and software components of the “processor” of the present disclosure may include and may be included within fixed and portable devices such as desktop, laptop, and/or server, and network of servers (cloud).

The terminology used herein is for the purpose of describing particular embodiments only and is not intended to be limiting the scope of the disclosure and is not intended to be exhaustive. While the present disclosure has been particularly shown and described with respect to preferred embodiments thereof, it will be understood by those skilled in the art that the foregoing and other changes in forms and details may be made without departing from the spirit and scope of the present disclosure. It is therefore intended that the present disclosure not be limited to the exact forms and details described and illustrated, but fall within the scope of the appended claims.

What is claimed is:

1. A hygrometer comprising:
a condensation sensor having an outer surface composed of a moisture sensitive hydrophilic material, wherein the moisture sensitive hydrophilic material has a direct current (DC) proton conductivity that varies over a decreasing temperature range, and wherein a maximum rate of increase in the DC proton conductivity over the decreasing temperature range is indicative of a dew point temperature.

2. The hygrometer of claim 1, wherein the maximum rate of increase in the DC proton conductivity is further indicative of a maximum rate of water molecules adsorption and their dissociation on a surface of the moisture sensitive hydrophilic material.

3. The hygrometer of claim 1, wherein a maximum in the DC proton conductivity of the moisture sensitive hydrophilic material over the decreasing temperature range is indicative of a transition to an icing condition, if the dew point temperature is greater than 0° C.

4. The hygrometer of claim 1, wherein a maximum in the DC proton conductivity of the moisture sensitive hydrophilic material over the decreasing temperature range is indicative of a frost point, if the dew point temperature is less than 0° C.

5. The hygrometer of claim 1, wherein the moisture sensitive hydrophilic material has chemical groups containing oxygen and is electronically insulating.

6. The hygrometer of claim 5, wherein the moisture sensitive hydrophilic material is composed of graphene oxide.

7. A hygrometer for detecting dew point, the hygrometer comprising:
a condensation sensor having an outer surface composed of a graphene oxide, wherein the graphene oxide has a direct current (DC) proton conductivity that varies over a decreasing temperature range, wherein a maximum rate of increase in the DC proton conductivity over the decreasing temperature range is indicative of a dew point temperature and a maximum rate of water molecules adsorption and their dissociation on a surface of the graphene oxide, and wherein a maximum in the DC proton conductivity of the graphene oxide over the decreasing temperature range is indicative of a transition to an icing condition, if the dew point temperature is greater than 0° C., or a frost point, if the dew point temperature is less than 0° C.

8. A system comprising:
a hygrometer comprising a condensation sensor having an outer surface composed of a moisture sensitive hydrophilic material, wherein the moisture sensitive hydrophilic material has a direct current (DC) proton conductivity that varies over a decreasing temperature range, and wherein a maximum rate of increase in the DC proton conductivity over the decreasing temperature range is indicative of a dew point temperature;
a signal conditioner; and
a processor configured to monitor the DC proton conductivity of the moisture sensitive hydrophilic material over the decreasing temperature range and to identify at least the maximum rate of increase in the DC proton conductivity over the decreasing temperature range.

9. The system of claim 8, wherein the maximum rate of increase in the DC proton conductivity is further indicative of a maximum rate of water molecules adsorption and their dissociation on a surface of the moisture sensitive hydrophilic material.

10. The system of claim 8, wherein a maximum in the DC proton conductivity of the moisture sensitive hydrophilic material over the decreasing temperature range is indicative of a transition to an icing condition, if the dew point temperature is greater than 0° C.

11. The system of claim 8, wherein a maximum in the DC proton conductivity of the moisture sensitive hydrophilic material over the decreasing temperature range is indicative of a frost point, if the dew point temperature is less than 0° C.

12. The system of claim 8, wherein the moisture sensitive hydrophilic material has chemical groups containing oxygen and is electronically insulating.

13. The system of claim 12, wherein the moisture sensitive hydrophilic material is composed of graphene oxide.

14. A method of determining dew point, the method comprising:
contacting a condensation sensor having an outer surface composed of a moisture sensitive hydrophilic material with moisture; and
measuring a change in direct current (DC) proton conductivity of the moisture sensitive hydrophilic material across the condensation sensor and over a decreasing temperature range, wherein a maximum rate of increase in the DC proton conductivity over the decreasing temperature range is indicative of a dew point temperature.

15. The method of claim 14, wherein the maximum rate of increase in the DC proton conductivity is further indicative of a maximum rate of water molecules adsorption and their dissociation on a surface of the moisture sensitive hydrophilic material.

16. The method of claim 14, wherein a maximum in the DC proton conductivity of the moisture sensitive hydrophilic material over the decreasing temperature range is indicative of a transition to an icing condition, if the dew point temperature is greater than 0° C.

17. The method of claim 14, wherein a maximum in the DC proton conductivity of the moisture sensitive hydrophilic material over the decreasing temperature range is indicative of a frost point, if the dew point temperature is less than 0° C.

18. The method of claim 14, wherein the moisture sensitive hydrophilic material has chemical groups containing oxygen and is electronically insulating.

19. The method of claim 18, wherein the moisture sensitive hydrophilic material is composed of graphene oxide.

20. The method of claim 19, wherein the graphene oxide is formed utilizing a filtering method of a water suspension of graphene oxide nanoparticles.
